(19) United States
(12) Patent Application Publication
(10) Pub. No.: US 2008/0160986 A1
(43) Pub. Date: Jul. 3, 2008

(54) Method for mobile communication service using dedicated frequency and apparatus thereof

(76) Inventors: Young-Min Oh, Seongnam-si (KR); Hyung-Sik Cho, Seongnam-si (KR); Byoung-Jin Choi, Seoul (KR); Jun-Gu Choi, Goyang-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/784,537

(22) Filed: Apr. 5, 2007

Related U.S. Application Data
(63) Continuation of application No. PCT/KR05/03297, filed on Oct. 6, 2005.

(30) Foreign Application Priority Data
Oct. 6, 2004 (KR) 10-2004-0079656
Oct. 6, 2004 (KR) 10-2004-0079659
Oct. 6, 2004 (KR) 10-2004-0079661

(51) Int. Cl. H04Q 7/20

(52) U.S. Cl. 455/422.1

(57) ABSTRACT

A method and device for mobile communication service using a dedicated frequency is disclosed. In one embodiment, the method for providing mobile communication service, in which a dedicated frequency conversion unit utilizes a dedicated frequency in a predetermined area may comprise i) receiving a signal of the dedicated frequency transmitted from the dedicated frequency base station, ii) corresponding a signal of common frequency to a signal of the received dedicated frequency, and iii) transmitting a signal of the corresponded common signal. In this embodiment, mobile communication terminals can receive a signal of the common frequency from the dedicated frequency conversion unit in the predetermined area and make a transition to a dedicated frequency bandwidth.

### RELATED APPLICATIONS

This application is a continuation application, and claims the benefit under 35 U.S.C. §§ 120 and 365 of PCT Application No. PCT/KR2005/003297, filed on Oct. 6, 2005 and, which is hereby incorporated by reference.

### BACKGROUND OF THE INVENTION

1. Field of the Invention

The present invention is directed to a method and apparatus for mobile communication service, specifically to a method and apparatus for mobile communication service using a dedicated frequency.

2. Description of the Related Technology

Mobile communication services use a method of receiving a call set signal, requested by a mobile communication terminal, by a base station, receiving this signal at a mobile communication switch and searching for another mobile communication switch in which the other mobile communication terminal that the call set is requested for is registered, and communicating using this search result. Thus, smooth transmission and reception of radiowaves between a base station and a mobile communication terminal are important for mobile communication service. For this reason, repeaters are installed between mobile communication terminals and a base station in shadow areas, where direct transmission and reception with a base station are difficult.

In certain areas or buildings that are in shadow areas to radiowaves, a repeater that is connected through cables from a base station is usually installed, and a multiple number of RF units (hereinafter referred to as “RU”) that are connected with the repeater through cables are connected to provide a mobile communication service.

### SUMMARY OF CERTAIN INVENTIVE ASPECTS

One aspect of the present invention provides a method and device for providing high quality mobile communication service having relatively low interference, with no PN pollution, by utilizing a separate, dedicated frequency in a particular area or building.

Another aspect of the present invention provides a method and device of mobile communication service for relatively reducing the service costs by utilizing a separate, dedicated frequency in a particular area or building.

Another aspect of the present invention provides a method and device of mobile communication service for relatively reducing an excessive signal output by utilizing a separate, dedicated frequency in a particular area or building.

Another aspect of this invention provides a method and device of mobile communication service having relatively little interference, with no PN pollution, by utilizing a separate, dedicated frequency on voice calls in a particular area or building.

Another aspect of this invention provides a method and device of mobile communication service having relatively little interference, with no PN pollution, by utilizing a separate, dedicated frequency on EVDO calls for some floors of a building with severe PN pollution.

Another aspect of the present invention can provide a mobile communication service method using a dedicated frequency, in which a dedicated frequency conversion unit utilizes a dedicated frequency in a predetermined area, the mobile communication service method comprising: i) receiving a signal of the dedicated frequency received from the dedicated frequency base station, ii) corresponding a common frequency to the received dedicated frequency and iii) transmitting a signal from the corresponded common frequency, wherein mobile communication terminals are characterized by receiving a signal of the common frequency from the dedicated frequency conversion unit in the predetermined area and making a transition to a dedicated frequency bandwidth.

Another aspect of the present invention can provide a mobile communication service method using a dedicated frequency, in which a dedicated frequency conversion unit utilizes a dedicated frequency in a predetermined area, the mobile communication service method comprising: i) receiving a signal of the common frequency received from the common frequency base station, ii) corresponding a dedicated frequency to the received common frequency and iii) transmitting a signal from the corresponded dedicated frequency, wherein mobile communication terminals are characterized by receiving a signal of the dedicated frequency from the common frequency conversion unit outside the predetermined area and making a transition to a common frequency bandwidth. Here, the predetermined area can be an entire building or some floors of a building. Moreover, the mobile communication service method using a dedicated frequency can further comprise: i) receiving a signal of the dedicated EVDO frequency from the dedicated frequency base station by an EVDO frequency conversion unit, in case the mobile communication terminal requests an EVDO call and ii) transmitting a signal of the common EVDO frequency corresponding to the received dedicated EVDO frequency by the EVDO frequency conversion unit, wherein the mobile communication terminal can receive a signal of the common EVDO frequency in the predetermined area and make a transition to a dedicated EVDO frequency bandwidth.

Moreover, the mobile communication service method using a dedicated frequency can further comprise transmitting one of the frequencies in the PRL (preferred roaming list) of the mobile communication terminal from the EVDO frequency conversion unit in case the mobile communication terminal is initialized in the predetermined area, wherein the mobile communication terminal can receive the transmitted signal, and make a transition to a signal of the common frequency received from the dedicated frequency conversion unit to a dedicated frequency.

Here, the frequency of a signal transmitted by the EVDO frequency conversion unit can be a first frequency of the PRL of the mobile communication terminal. Here, when the predetermined area is a building, the EVDO conversion unit can be installed on each floor of the building or on upper floors, where PN pollution is severe. Here, the common frequency can be one of the PRL of a 1× or 2G mobile communication terminal. Here, the dedicated frequency can be a frequency that is not in the PRL of the mobile communication terminal.

Still another aspect of the present invention can provide a mobile communication service device using a dedicated frequency, in which a dedicated frequency conversion unit utilizes a dedicated frequency in a predetermined area, the mobile communication service device comprising: i) a reception unit receiving a signal of dedicated frequency from a dedicated frequency base station ii) a dedicated frequency combining unit corresponding the received signal to a signal of common frequency and iii) a transmission unit transmitting a signal of common frequency corresponding to a signal of the dedicated frequency, wherein mobile communication terminals are characterized by receiving a signal of the common frequency from the dedicated frequency conversion unit in the predetermined area and making a transition to a dedicated frequency bandwidth.

Still another aspect of the present invention can provide a mobile communication service device using a dedicated frequency, in which a common frequency conversion unit utilizes a dedicated frequency in a predetermined area, the mobile communication service device comprising: i) a reception unit receiving a signal of common frequency from a common frequency base station, ii) a common frequency combining unit corresponding the received signal to a signal of dedicated frequency and iii) a transmission unit transmitting a signal of dedicated frequency corresponding to a signal of the common frequency, wherein mobile communication terminals are characterized by receiving a signal of the dedicated frequency from the common frequency conversion unit outside the predetermined area and making a transition to a common frequency bandwidth.

Here, the predetermined area can be an entire building or some floors of a building. Here, the common frequency can be one of the PRL of the mobile communication terminal. Here, the dedicated frequency can be a frequency that is not in the PRL of the mobile communication terminal.

Yet another aspect of the present invention can provide a mobile communication service system using a dedicated frequency in a predetermined area, the mobile communication service system comprising: i) a common frequency conversion unit transmitting a signal of the dedicated frequency corresponding to a received signal of the common frequency and ii) a dedicated frequency conversion unit transmitting a signal of the common frequency corresponding to a received signal of the dedicated frequency, wherein mobile communication terminals are characterized by receiving a signal of common frequency from the dedicated frequency conversion unit and making a transition to a dedicated frequency, and receiving a signal of dedicated frequency from the common frequency conversion unit and making a transition to a common frequency.

Here, the predetermined area can be an entire building or some floors of a building. Here, the common frequency conversion unit can be installed in a border line of the predetermined area.

Moreover, the mobile communication service system can further comprise an EVDO frequency conversion unit receiving a dedicated EVDO frequency as an input signal and transmitting a corresponding common EVDO frequency as an output signal, wherein a signal of common EVDO frequency can be received from the EVDO frequency conversion unit and made a transition to a dedicated EVDO frequency, in case the mobile communication terminal requests a data call.

Here, the EVDO frequency conversion unit can transmit one of the frequency signals in the PRL of a mobile communication terminal in case the mobile communication terminal is initialized, whereas the mobile communication terminal can receive the transmitted signal and make a transition of a signal of the common frequency, received from the dedicated frequency conversion unit, to a dedicated frequency.

Here, the frequency of a signal transmitted by the EVDO frequency conversion unit can be a first frequency of the PRL of the mobile communication terminal. Here, in case the predetermined area is a building, the EVDO frequency conversion unit can be installed on each floor of the building or on upper floors, where PN pollution is severe.

Furthermore, the mobile communication service system using a dedicated frequency can further comprise a dedicated repeater for amplifying signals in shadow areas of the predetermined area. Here, the shadow areas can comprise an elevator or a staircase, or combinations thereof.

At least one aspect of the present invention solves aforementioned problems.

### BRIEF DESCRIPTION OF THE DRAWINGS

FIG. 1 shows a typical facility for providing a mobile communication service in a building.

FIG. 2 shows a scope of mobile communication service using a dedicated frequency, based on one embodiment of the present invention.

FIG. 3 shows another scope of mobile communication service using a dedicated frequency, based on another embodiment of the present invention.

FIG. 4 shows a brief illustration of mobile communication system using a dedicated frequency, based on one embodiment of the present invention.

FIG. 5 shows a flowchart of the signal process method carried out in a dedicated frequency conversion unit, based on one embodiment of the present invention.

FIG. 6 shows a flowchart of the signal process method carried out in a common frequency conversion unit, based on another embodiment of the present invention.

FIG. 7 shows a facility for providing a mobile communication service using a signal of dedicated frequency for an entire building above the ground, based on one embodiment of the present invention.

FIG. 8 shows a facility for providing a mobile communication service using a signal of dedicated frequency for an entire building above and below the ground, based on another embodiment of the present invention.

FIG. 9 shows a facility for providing a mobile communication service using a signal of dedicated frequency inside a building basement, based on one embodiment of the present invention.

FIG. 10 shows a facility for providing a mobile communication service using a signal of dedicated frequency on some floors of a building, based on one embodiment of the present invention.

FIG. 11 shows a plan view specifying locations for measuring a radiowave environment on a particular floor, based on one embodiment of the present invention.

FIG. 12 shows the data that measured the radiowave environment on a particular floor of a building, based on one embodiment of the present invention.

### DETAILED DESCRIPTION OF CERTAIN INVENTIVE EMBODIMENTS

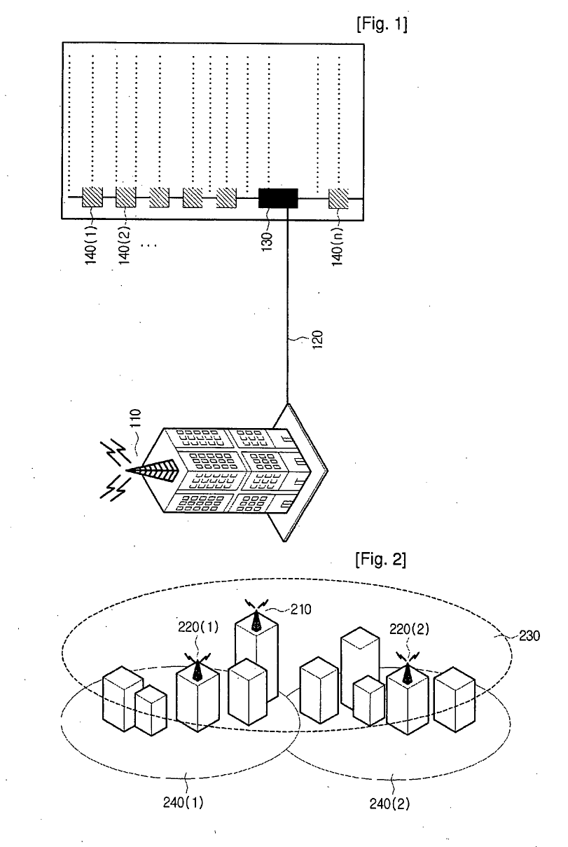

FIG. 1 illustrates a typical facility for servicing mobile communication in a building. Referring to FIG. 1, the facility includes a base station 110, an optical cable 120, optical repeater 130, and RU 140(1), 140(2), . . . , 140(n) (hereinafter referred to as 140).

The base station 110 is connected with a switch on a mobile communication system, communicating radiowaves with mobile communication terminals, and is connected with an optical repeater 130 through optical cables 120. The optical cables 120 connect the base station 110, optical repeater 130, and RU 140, to transmit RF signals. The optical repeater 130 and RU 140 are installed inside a building to secure call quality by minimizing the interference between radiowaves and overcoming the RF damage in the route. Here, the optical repeater 130 is a signal source directly connected with a base station 110 in order to provide a mobile communication service, whereas the RU 140 amplifies and outputs signals received from an optical repeater 130 on each floor inside a building.

According to the typical system, however, providing a service using amplified signals from a base station 110 through an optical repeater 130 or optical cables 120 requires installation of cables in a particular area or on each floor of a building as well as an RF antenna at the end of each cable. Thus, when the service area is particularly wide, or the building is tall, a large quantity of cables and RF antennas are required, resulting in a rise in service costs. Besides, when there is severe PN pollution with the surrounding base stations, signals need to be amplified for output, resulting in a relatively excessive signal output.

Hereinafter, embodiments of the method and device for mobile communication service using a dedicated frequency will be described in detail with reference to the accompanying drawings. In describing with reference to the accompanying drawings, any identical or corresponding components, regardless of the figure numbers, will be given the same reference numbers and the duplicate description thereof will be omitted.

FIG. 2 shows a scope of mobile communication service using a dedicated frequency, based on one embodiment of this invention. FIG. 2 illustrates a base station 210 outputting a signal of dedicated frequency, a base station 220(1), 220(2) (hereinafter referred to as 220) outputting a signal of common frequency, a scope 230 in which signals of dedicated frequency communicate, and a scope 240(1), 240(2) (hereinafter referred to as 240) in which signals of common frequency communicate. Particularly, the scope of mobile communication service for middle- or small-sized buildings in an urban area is illustrated.

In one embodiment, dedicated frequency refers to a separate frequency used in the mobile communication service method using a dedicated frequency. A dedicated frequency can be a frequency that is not registered in the PRL (preferred roaming list; hereinafter referred to as “PRL”) of a 1× or 2G mobile communication terminal. The PRL is a roaming area data that records the frequency data of a signal used in communication of a call in case the mobile communication terminal is being roamed. Typically, the PRL of a 1× mobile communication terminal has the frequencies of Ch 50, 275, 325, 75, 125, 300, and 250, and a 2G mobile communication terminal Ch 75, 125, 300, and 250. In one embodiment, the frequency for 1× can be Ch 350, and 2G Ch 375. Other frequencies can be common frequencies.

The base station 210 outputting a signal of dedicated frequency communicates a signal of the dedicated frequency with a mobile communication terminal, whereas the base station 220 outputting a signal of common frequency, not dedicated frequency, communicates a signal of common frequency with a mobile communication terminal. The scope 230 communicating signals of dedicated frequency that corresponds to the base station 210 outputting signals of dedicated frequency partially coincides with the scope 240 communicating signals of common frequency that corresponds to the general base station 220 outputting signals of common frequency. Here, the scope 230 communicating signals of dedicated frequency can be set by grouping a plurality of buildings surrounding the base station 210 outputting signals of dedicated frequency. Here, the signals of dedicated frequency and/or common frequency can be voice calls or data calls.

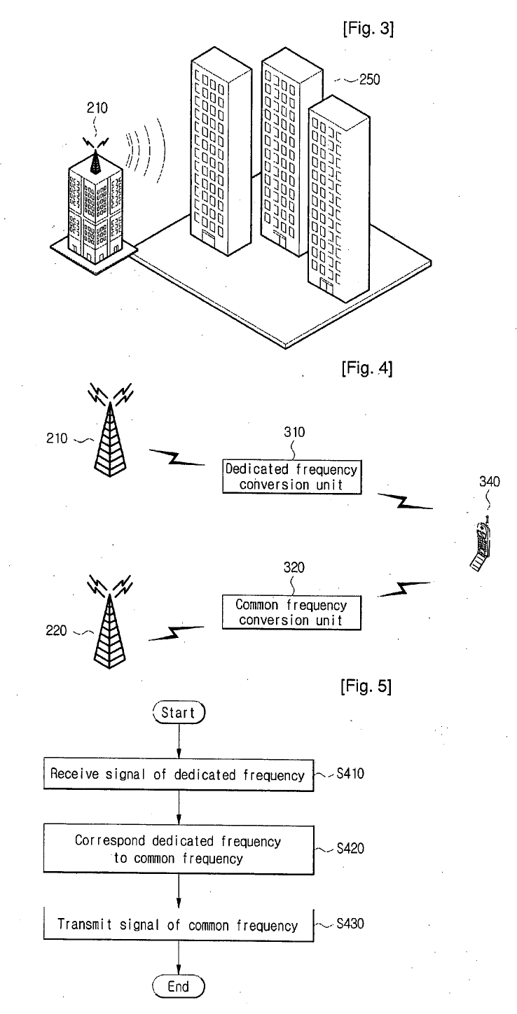

FIG. 3 shows another scope of mobile communication service using a dedicated frequency, based on one embodiment of this invention. Illustrated in FIG. 3 are a base station 210 outputting signals of dedicated frequency and a high-rise apartment complex 250.

The inside of a high-rise building, such as a high-rise apartment complex 250, can have a serious problem of PN pollution because of the height as well as being inside. Thus, the mobile communication service method using a dedicated frequency can be used in high-rise buildings such as a high-rise apartment complex 250.

Here, as described above, the mobile communication service method using a dedicated frequency can be not only used in particular buildings but also applied in shadow areas of mobile communication service or in areas of severe PN pollution, as necessary.

Moreover, in case the mobile communication terminal moves from the scope 240 communicating signals of common frequency to the scope 230 communicating signals of dedicated frequency, or vice versa, the mobile communication terminal must be made a transition to a terminal using signals of dedicated frequency, or vice versa. The device for this function will be described below.

FIG. 4 shows a brief illustration of mobile communication system using a dedicated frequency, based on one embodiment of the present invention. Referring to FIG. 4, the mobile communication system using a dedicated frequency may comprise a base station 210 outputting signals of dedicated frequency, a base station 220 outputting signals of common frequency, a dedicated frequency conversion unit 310, a common frequency conversion unit 320, and a of mobile communication terminal 340.

The dedicated frequency conversion unit 310 is a beacon device making a transition of the mobile communication terminal 340 to a dedicated frequency bandwidth, in case the mobile communication terminal 340 moves into a scope corresponding to the base station 210 outputting signals of dedicated frequency. Typically, a beacon device is an accessory equipment allowing the mobile communication terminal 340 to have a smooth communication by making frequency assignment (FA) even with a small number of channels. Here, this device allows a transition to a dedicated frequency bandwidth such that the mobile communication terminal 340 can use the dedicated frequency. Hence, when the mobile communication terminal 340 moves into an area where signals from the dedicated frequency conversion unit 310 can be received, the dedicated frequency conversion unit 310 receives signals of dedicated frequency from the base station 210 outputting signals of dedicated frequency and outputs signals of common frequency corresponding to this, and the mobile communication terminal 340 makes a transition to a dedicated frequency bandwidth. The mobile communication terminal 340, when in an idle state, synchronizes with the common frequency outputted by the dedicated frequency conversion unit 310 at intervals of the paging slot monitoring, and makes a transition to a dedicated frequency bandwidth, when in a traffic state, by conducting the non slot monitoring.

The common frequency conversion unit 320 is a beacon device making a transition of the mobile communication terminal 340 to a common frequency bandwidth in case the mobile communication terminal 340 moves into a scope corresponding to the base station 220 outputting signals of common frequency. Hence, when the mobile communication terminal 340 moves into an area where signals from the common frequency conversion unit 320 can be received, the common frequency conversion unit 320 receives signals of common frequency from the base station 220 outputting signals of common frequency and outputs signals of dedicated frequency corresponding to this, and the mobile communication terminal 340 makes a transition to a common frequency bandwidth. The processes for making a transition in an idle state and a traffic state are identical to those of a dedicated frequency conversion unit 310.

The mobile communication service system using a dedicated frequency can further comprise an EVDO (Evolution Data Only or Evolution Data Optimized; hereinafter referred to as “EVDO”) frequency conversion unit (unillustrated). The EVDO frequency conversion unit receives signals of dedicated EVDO frequency and outputs signals of common EVDO frequency corresponding to this, and the mobile communication terminal 340 can make a transition to a dedicated EVDO frequency bandwidth, in the method as described above, by receiving signals of common EVDO frequency from the EVDO frequency conversion unit. Here, the mobile communication terminal 340 can be a 1× Parking terminal among Hybrid terminals. Hybrid refers to a method of monitoring 1× or EVDO by a terminal, and is classified into 1× Parking, Long Sleep Hybrid, and Full Hybrid. This classification is based on the cycle of monitoring an EVDO signal in 1×. Since 1× Parking terminals, among Hybrid terminals, do not monitor EVDO unless a user requests an EVDO data call, the EVDO frequency conversion unit makes a transition of the mobile communication terminal 340 to a dedicated frequency bandwidth, as described above, when the mobile communication terminal 340 requests an EVDO call.

Here, the EVDO frequency conversion unit can transmit signals of one of the frequencies in the PRL of the mobile communication terminal 340, in case the mobile communication terminal 340 is initialized. In this case, the mobile communication terminal 340 can receive signals transmitted by the EVDO frequency conversion unit and a common frequency from the dedicated frequency conversion unit to make a transition to a dedicated frequency. Hence, when the mobile communication terminal 340 is re-initialized after being turned off due to an abnormal supply of power, the signals of common frequency stored inside the mobile communication terminal can be used, and the mobile communication terminal 340 can be later made transition to a dedicated frequency bandwidth through the dedicated frequency conversion unit 310. Here, the frequency of the transmitted signal among the PRL of the mobile communication terminal 340 can be a first frequency in the PRL.

Moreover, the mobile communication service system using a dedicated frequency can further comprise a dedicated repeater for providing a mobile communication service by amplifying signals in a shadow area of a predetermined area. Here a shadow area can be an elevator, staircase, or other areas where the signals outputted by the frequency conversion unit do not reach.

Below, the methods carried out by a dedicated frequency conversion unit 310 and common frequency conversion unit 320 are described in detail.

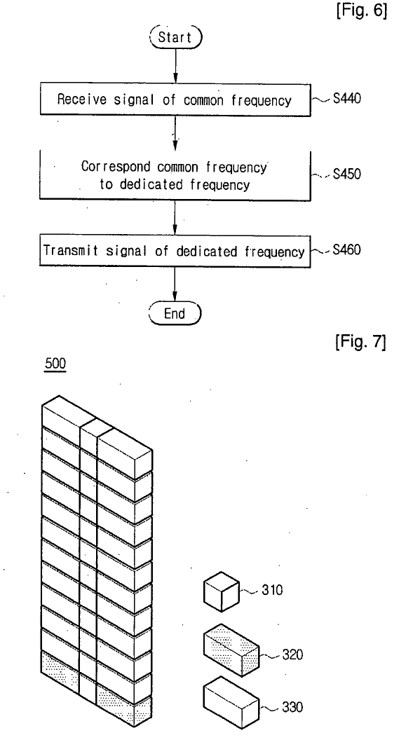

FIG. 5 shows a flowchart of the signal process method carried out in a dedicated frequency conversion unit, based on one embodiment of the present invention, and FIG. 6 a flowchart of the signal process method carried out in a common frequency conversion unit, based on another embodiment of the present invention.

Referring to FIG. 5, in step S410, the dedicated frequency conversion unit 310 receives a signal of dedicated frequency from the base station 210 outputting a signal of dedicated frequency.

In step S420, the dedicated frequency conversion unit 310 corresponds the received signal of dedicated frequency to a signal of common frequency. For example, the dedicated frequency for 1× is of Ch 350, which is not included in the PRL of the mobile communication terminal 340, the dedicated frequency conversion unit 310 receives this signal to correspond to a frequency included in the PRL or another common frequency. In this case, the frequency included in the PRL can be one of the channels of Ch 50, 275, 325, 75, 125, 300, and 250. For 2G, in case the dedicated frequency is of Ch 375, which is not included in the PRL of the mobile communication terminal 340, a frequency included in the PRL or another common frequency is corresponded. In this case, the frequency included in the PRL can be one of the channels of Ch 75, 125, 300, and 250. As described above, by corresponding a signal of dedicated frequency to a signal of common frequency, the mobile communication terminal 340 using signals of common frequency can receive signals of outputted common frequency to make a transition to a dedicated frequency bandwidth.

In step S430, the dedicated frequency conversion unit 310 outputs a signal of common frequency corresponding to the received dedicated frequency. Later, the mobile communication terminal 340 receives a signal of common frequency and makes a transition to a dedicated frequency bandwidth to receive a mobile communication service by use of signals of dedicated frequency.

Referring to FIG. 6, the method carried out by the common frequency conversion unit 320 will be described below in terms of differences from the method by the dedicated frequency conversion unit 310.

In step S440, the common frequency conversion unit 320 receives a signal of common frequency from the base station 220 outputting a signal of common frequency. In step S450, the common frequency conversion unit 320 corresponds the received signal of dedicated frequency to a signal of common frequency. For example, the common frequency for 1× is a common frequency included in the PRL or another common frequency, the common frequency conversion unit 320 can receive this signal to correspond to the dedicated frequency of Ch 350, which is not included in the PRL of the mobile communication terminal 340. For 2G, in case the common frequency is a frequency included in the PRL or another common frequency, the common frequency conversion unit 320 can receive this signal to correspond to the dedicated frequency of Ch 375, which is not included in the PRL of the mobile communication terminal 340.

In step S460, the common frequency conversion unit 320 outputs a signal of dedicated frequency corresponding to the received common frequency. Later, the mobile communication terminal 340 receives a signal of dedicate frequency and makes a transition to a common frequency bandwidth to receive a mobile communication service by use of signals of common frequency.

The dedicated frequency conversion unit 310 and common frequency conversion unit 320 must be installed to meet the characteristics of the area, for which the mobile communication service is to be provided, in order for these units to be pre-installed to make transitions of frequency bandwidths of the mobile communication terminal 340. Details for this will be described in each embodiment below.

A general explanation was set forth above on drawings illustrating a mobile communication system using a dedicated frequency based on one embodiment of this invention, and on each of its components. Hereinafter, the description will focus on specific embodiments involving particular areas and buildings to which a mobile communication system using a dedicated frequency is applied, with reference to the accompanying drawings. Embodiments of the invention may be divided into two main cases according to the areas in which they are utilized. A first is the case of using a signal of dedicated frequency in the entire building, and the other is the case of using a signal of dedicated frequency for a particular frequency (for example, an EVDO frequency) only in the upper floors where PN pollution is severe, while using a signal of common frequency in the lower floors. The case of using a signal of dedicated frequency in the entire building will be described first.

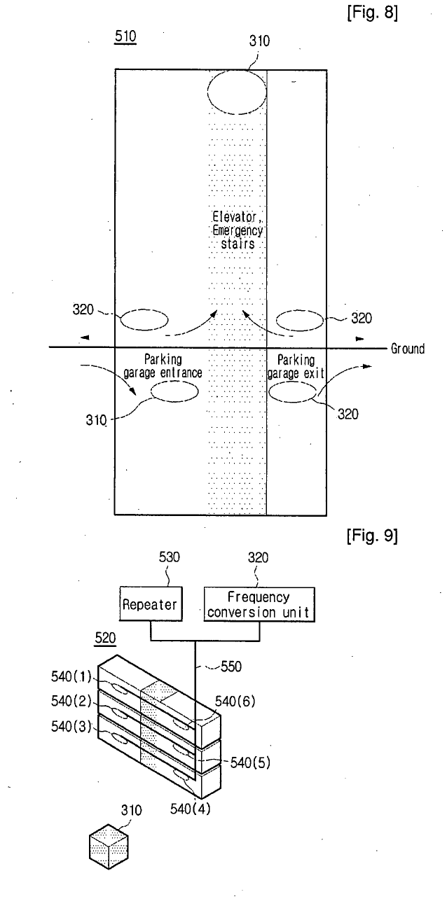

FIG. 7 shows a facility for providing a mobile communication service for a building above the ground based on one embodiment of the present invention; FIG. 8 shows a facility for providing a mobile communication service for an entire building above and below the ground based on another embodiment of the present invention; and FIG. 9 shows a facility for providing a mobile communication service inside a building basement based on one embodiment of the present invention. FIG. 7 illustrates a building 500 in which a signal of dedicated frequency is used, wherein a mobile communication service system using a dedicated frequency may comprise a dedicated frequency conversion unit 320, a common frequency conversion unit 320, and an EVDO frequency conversion unit 330.

The dedicated frequency conversion unit 310 is installed in a location that must be passed when the mobile communication terminal 340 is moved into the building or used inside the building, such as an elevator or emergency stairs of the building 500. Thus, when the mobile communication terminal 340 is moved into the building, the dedicated frequency conversion unit 310 makes a transition to a dedicated frequency bandwidth.

The common frequency conversion unit 320 is installed at the exit of the building 500 and outputs a signal of dedicated frequency in the direction outward from the building 500, to make a transition to a common frequency bandwidth when the mobile communication terminal 340 is moved from the interior to the exterior of the building 500.

The EVDO frequency conversion unit 330 is installed on each floor of the building 500 such that when the mobile communication terminal 340 uses a service for EVDO calls, a signal of dedicated frequency may be used. Also, when the mobile communication terminal 340 is reinitialized after being turned off abnormally, such as when the supply is cut off, the EVDO frequency conversion unit 330 can allow the mobile communication terminal 340 in an area where a signal is not received from the dedicated frequency conversion unit 310 to make a transition to a dedicated frequency bandwidth via the dedicated frequency conversion unit 310 by allowing the use of a stored signal of common frequency.

FIG. 8 illustrates a building 510 in which a signal of dedicated frequency is used, wherein a mobile communication service system using a dedicated frequency may comprise a dedicated frequency conversion unit 310 and a common frequency conversion unit 320, and can preferably further comprise an EVDO frequency conversion unit 330 on each floor.

FIG. 9 illustrates a building basement 520 in which a signal of dedicated frequency is used, wherein a mobile communication service system using a dedicated frequency may comprise a dedicated frequency conversion unit 310, a common frequency conversion unit 320, and a common frequency repeater 530, and can preferably further comprise an EVDO frequency conversion unit 330 on each floor. Also, to use a signal of common frequency, common frequency antennas 540(1), 540(2), . . . , 540(n) (hereafter referred to as 540) are installed, and cables 550 to connect them are also installed to provide a more effective mobile communication service in certain shadow areas.

A description was set forth above on using a signal of dedicated frequency in the entire building. Hereinafter, a description will be given on using a signal of dedicated frequency only in certain floors of a building.

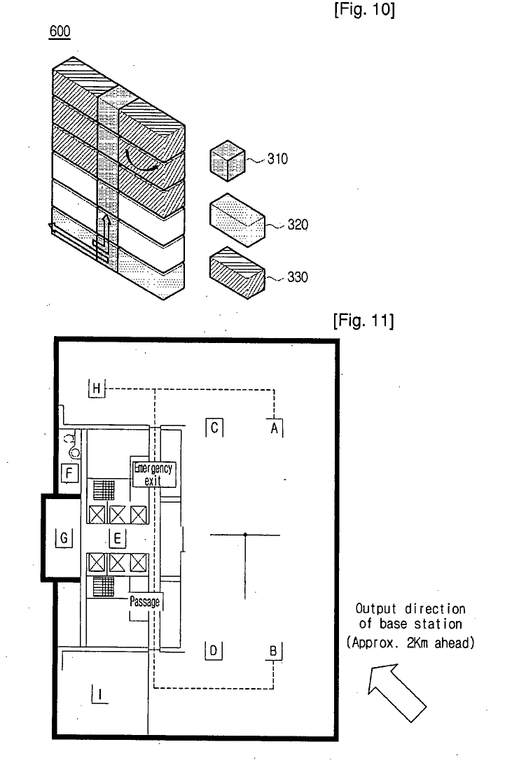

FIG. 10 shows a facility for providing a mobile communication service using a signal of dedicated frequency on some floors of a building, based on one embodiment of the present invention. FIG. 10 illustrates a dedicated frequency conversion unit 310, a common frequency conversion unit 320, and an EVDO frequency conversion unit 330, and the description will focus on differences from the embodiments set forth above.

The building 600 using a signal of dedicated frequency is divided into upper floors where PN pollution is severe and lower floors where it is not. Here, although the dedicated frequency conversion units 310 can cover the entire building as they are installed in elevators and emergency stairs, an EVDO frequency conversion unit 330 must be installed on each floor to use a signal of dedicated frequency for EVDO calls. However, on lower floors where PN pollution relatively low, there is no need to use a signal of dedicated frequency additionally for EVDO calls such that on the lower floors of a building, a signal of common frequency is used without installing an EVDO frequency conversion unit 330.

Therefore, selectively installing the EVDO frequency conversion units 330 may render an advantage of implementing an economical mobile communication system. Also, the lower floors on a building or the exterior of the building are shadow areas with respect to a signal of dedicated frequency, and a signal of common frequency can be used in these areas, so when a mobile communication terminal 340 using a signal of dedicated frequency for EVDO calls is moved to such an area, a transition is made to a common frequency bandwidth.

The description set forth above dealt with areas where a mobile communication service using dedicated frequency may be provided for an entire building and for parts of a building. Hereinafter, the descriptions will focus on the radiowave environment on particular floors in a building with regard to experimental data.

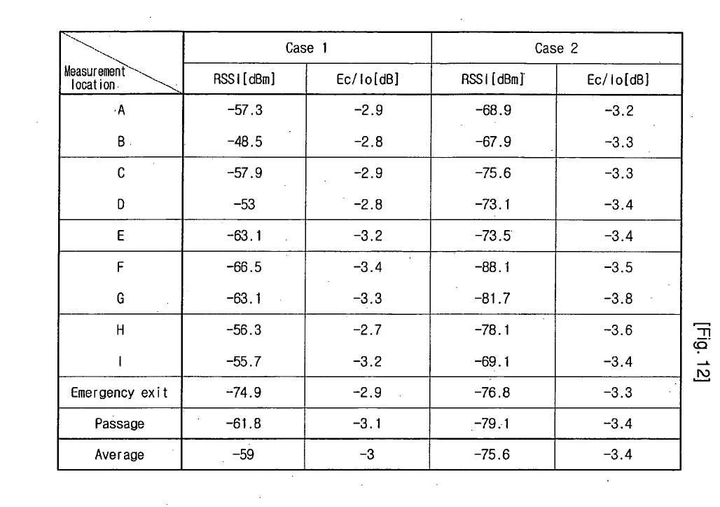

FIG. 11 shows a plan view specifying locations for measuring a radiowave environment on a particular floor, based on one embodiment of the present invention, and FIG. 12 shows the data that measured the radiowave environment on a particular floor of a building, based on one embodiment of the present invention.

As shown in FIG. 11, the measurement of a radiowave environment based on one embodiment of the invention was performed at predetermined locations on the tenth to fifteenth floors of a particular building, under the following conditions:

TABLE 1

| | | Measurement | Measurement |
|---|---|---|---|
| | | method | category |
| Case 1 | Measurement of common | Measuring common | RSSI, Ec/Io, |
| | frequency signals | frequency after | call |
| | using cables of prior art | installing cables | success/failure |
| Case 2 | Measurement of | Measuring dedicated | RSSI, Ec/Io, |
| | dedicated frequency | frequency after | call |
| | signals based on one | installing dedicated | success/failure |
| | embodiment of | frequency system | |
| | present invention | | |

The predetermined locations are: left of the front windows (A), right of the front windows (B), left of the office space (C), right of the office space (D), front of the elevators (E), the restroom (F), the lounge (G), back left of the office space (H), back right of the office space (I), the emergency exit, and the passage by the right emergency exit. The base station outputting a signal of dedicated frequency is located approximately 2 km to the front of the building.

FIG. 12 lists the measured radiowave environment data at particular locations described above. The measured radiowave environment data are averaged values of the data measured on the tenth to fifteenth floors of the particular building. Here, the measurement of Ec/Io yielded satisfactory results with −3 dB for case 1 and −3.4 dB for case 2, and the measurement of Rx power also yielded satisfactory results with −59 dBm for case 1 and −75.6 dBm for case 2.

In the foregoing embodiment, the mobile communication service system using a dedicated frequency provides an installation cost that is reduced by 40% compared to the installation cost of a mobile communication service system using cables based on prior art. Here, the cost of the dedicated frequency base station is calculated to be ⅓ of the normal cost, based on the fact that three building groups may be served from one base station. Therefore, with an increased number of building groups served per dedicated frequency base station, the cost involved in installing a system based on one embodiment of the present invention will further be reduced.

According to at least one embodiment, the method for mobile communication service using a dedicated frequency and apparatus thereof, by utilizing a separate, dedicated frequency in a particular area or building with severe PN pollution, can provide a high quality mobile communication service having relatively low interference, with no PN pollution.

Also, the method for mobile communication service using a dedicated frequency and apparatus thereof, by utilizing a separate, dedicated frequency in a particular area or building, can reduce the service costs compared to a system using cables based on prior art.

Furthermore, the method for mobile communication service using a dedicated frequency and apparatus thereof, by utilizing a separate, dedicated frequency in a particular area or building, can reduce an excessive signal output.

Also, the method for mobile communication service using a dedicated frequency and apparatus thereof can provide a high quality mobile communication service having relatively little interference, with no PN pollution, by utilizing a separate, dedicated frequency on voice calls in a building with severe PN pollution.

In addition, the method for mobile communication service using a dedicated frequency and apparatus thereof can provide a high quality mobile communication service having relatively little interference, with no PN pollution, by utilizing a separate, dedicated frequency on EVDO calls for some floors of a building with severe PN pollution.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of providing a mobile communication service, comprising:
receiving a signal of a dedicated frequency from a dedicated frequency base station;
obtaining a predetermined common frequency corresponding to the received dedicated frequency which has a different bandwidth from that of the common frequency; and
transmitting a signal of the obtained common frequency to at least one mobile communication terminal entering a predetermined area so as to control the at least one mobile communication terminal such that the terminal communicates data with the dedicated frequency base station via the dedicated frequency while the terminal is being located in the predetermined area.

2. The method of claim 1, wherein the method is performed by a dedicated frequency conversion unit.

3. The method of claim 1, wherein the predetermined area comprises i) the entire area of a building, including a plurality of floors, or ii) at least the top two floors of the building.

4. A method of providing a mobile communication service, comprising:
receiving a signal of a common frequency from a common frequency base station;
obtaining a predetermined dedicated frequency corresponding to the received common frequency which has a different bandwidth from that of the dedicated frequency; and
transmitting the obtained dedicated frequency signal to at least one mobile communication terminal leaving a predetermined area so as to control the at least one mobile communication terminal such that the terminal communicates data with the common frequency base station via the common frequency while the terminal is being located outside of the predetermined area.

5. The method of claim 4, wherein the method is performed by a common frequency conversion unit.

6. The method of claim 4, wherein the predetermined area includes i) the entire area of a building, including a plurality of floors, or ii) at least the top two floors of the building.

7. The method of claim 1, further comprising:
in response to an evolution data optimized (EVDO) call from the mobile communication terminal, receiving, at an EVDO frequency conversion unit, a signal of a dedicated EVDO frequency from the dedicated frequency base station; and
transmitting, at the EVDO frequency conversion unit, a signal of a common EVDO frequency corresponding to the received dedicated EVDO frequency so as to control the mobile communication terminal such that the terminal communicates data with the dedicated frequency base station via the dedicated EVDO frequency.

8. The method of claim 7, further comprising:
transmitting, at the EVDO frequency conversion unit, one of the frequencies listed in the preferred roaming list (PRL) of the mobile communication terminal in case the mobile communication terminal is initialized in the predetermined area,
wherein the transmitted PRL frequency signal is configured to control the mobile communication terminal so as to communicate data with the dedicated frequency base station via the dedicated EVDO frequency.

9. The method of claim 8, wherein the transmitted PRL frequency is the first frequency of the PRL.

10. The method of claim 7, wherein, when the predetermined area is a building, including a plurality of floors, the EVDO conversion unit is installed on at least the top two floors of the building.

11. The method of claim 1, wherein the common frequency comprises frequencies which are listed in the preferred roaming list (PRL) of the mobile communication terminal.

12. The method of claim 1, wherein the dedicated frequency comprises frequencies which are not listed in the preferred roaming list (PRL) of the mobile communication terminal.

13. A system for providing a mobile communication service, comprising:
a receiver configured to receive a signal of a dedicated frequency from a dedicated frequency base station;
a dedicated frequency combining unit configured to obtain a predetermined common frequency corresponding the received dedicated frequency signal which has a different bandwidth from that of the common frequency; and
a transmitter configured to transmit the obtained common frequency signal to at least one mobile communication terminal entering a predetermined area, wherein the transmitted common frequency is configured to control the at least one mobile communication terminal so as to communicate data with the dedicated frequency base station via the dedicated frequency while the at least one mobile communication terminal is being located in the predetermined area.

14. A system for providing a mobile communication service, comprising:
a receiver configured to receive a signal of a common frequency from a common frequency base station;
a common frequency combining unit configured to obtain a predetermined dedicated frequency corresponding to the received common frequency signal which has a different bandwidth from that of the dedicated frequency; and
a transmitter configured to transmit the obtained dedicated frequency signal to at least one mobile communication terminal leaving a predetermined area, wherein the transmitted dedicated frequency is configured to control the at least one mobile communication terminal so as to communicate data with the common frequency base station via the common frequency while the at least one mobile communication terminal is being located outside of the predetermined area.

15. The system of claim 13, wherein the predetermined area comprises i) the entire area of a building, including a plurality of floors, or ii) at least the top two floors of the building.

16. The system of claim 13, wherein the common frequency comprises frequencies which are listed in the preferred roaming list (PRL) of a 1× or 2G mobile communication terminal.

17. The system of claim 13, wherein the dedicated frequency comprises frequencies which are not listed in the preferred roaming list (PRL) of the mobile communication terminal.

18. A system for providing a mobile communication service, comprising:
a common frequency conversion unit configured to transmit a signal of a dedicated frequency, to a mobile communication terminal, corresponding to a received signal of a common frequency which has a different bandwidth from that of the dedicated frequency, wherein the transmitted dedicated frequency is configured to control the mobile communication terminal so as to communicate data with a common frequency base station via the common frequency while the mobile communication terminal is being located outside of the predetermined area; and
a dedicated frequency conversion unit configured to transmit a signal of the common frequency, to the mobile communication terminal, corresponding to a received signal of the dedicated frequency, wherein the transmitted common frequency is configured to control the mobile communication terminal so as to communicate data with a dedicated frequency base station via the dedicated frequency while the mobile communication terminal is being located in the predetermined area.

19. The system of claim 18, wherein the predetermined area comprises i) the entire area of a building, including a plurality of floors, or ii) at least the top two floors of the building.

20. The system of claim 18, wherein the common frequency conversion unit is installed along the perimeter of the predetermined area.

21. The system of claim 18, further comprising a dedicated repeater configured to amplify signals in shadow portions of the predetermined area.

22. The system of claim 21, wherein the shadow portions comprise an elevator or a staircase, or combinations thereof.

23. A method of providing a mobile communication service, comprising:
receiving a signal of a first frequency from a first base station;
obtaining a predetermined second frequency corresponding to the received first frequency which has a different bandwidth from that of the second frequency; and
transmitting a signal of the obtained second frequency to at least one mobile communication terminal moving to a predetermined area so as to control the at least one mobile communication terminal.

24. The method of claim 23, wherein the at least one mobile communication terminal is controlled such that the terminal communicates data with the first frequency base station via the first frequency while the terminal is being located in the predetermined area

25. The method of claim 24, wherein the first frequency comprises frequencies which are not listed in the preferred roaming list (PRL) of the mobile communication terminal.

26. The method of claim 24, wherein the second frequency comprises frequencies which are listed in the preferred roaming list (PRL) of the mobile communication terminal.

27. The method of claim 24, wherein the predetermined area comprises i) the entire area of a building, including a plurality of floors, or ii) at least the top two floors of the building.

28. The method of claim 24, wherein the predetermined area is outside a building, including a plurality of floors, or certain floors of the building.

29. A system for providing a mobile communication service, comprising:
means for receiving a signal of a first frequency from a first base station;
means for obtaining a predetermined second frequency corresponding to the received first frequency which has a different bandwidth from that of the second frequency; and
means for transmitting a signal of the obtained second frequency to at least one mobile communication terminal moving to a predetermined area so as to control the at least one mobile communication terminal such that the terminal communicates data with the first frequency base station via the first frequency while the terminal is being located in the predetermined area.
